(19) United States
(12) Patent Application Publication
(10) Pub. No.: US 2018/0010514 A1
(43) Pub. Date: Jan. 11, 2018

(54) CONTROL METHOD FOR INLET SWIRL DEVICE

(71) Applicant: BorgWarner Inc., Auburn Hills, MI (US)

(72) Inventors: John SHUTTY, Clarkston, MI (US); Urs HANIG, Stuttgart (DE)

(73) Assignee: BorgWarner Inc., Auburn Hills, MI (US)

(21) Appl. No.: 15/544,535

(22) PCT Filed: Jan. 6, 2016
(86) PCT No.: PCT/US16/12281

§ 371 Date: Jul. 19, 2017

Related U.S. Application Data
(60) Provisional application No. 62/105,880, filed on Jan. 21, 2015.

(51) Int. Cl. F02B 37/24; F02D 41/02; F02D 41/00; F02D 41/12; F04D 29/44; F04D 27/02; F04D 29/42

(52) U.S. Cl. CPC F02B 37/24; F02D 41/0007; F02D 41/023; F02D 41/12; F02D 41/0005; F04D 27/0246; F04D 29/4213; F04D 29/444; F05D 2220/40; F02D 2041/0015

(57) ABSTRACT

A number of variations may include a method comprising selectively actuating an inlet swirl device to cause a compressor to windmill at a higher speed during an operation mode where fuel consumption of an engine in the vehicle is at a minimal or before an acceleration event.

### CROSS-REFERENCE TO RELATED APPLICATIONS

This application claims the benefit of U.S. Provisional Application No. 62/105,880 filed Jan. 21, 2015.

### TECHNICAL FIELD

The field to which the disclosure generally relates to includes engine systems including a turbocharger.

### BACKGROUND

An engine may include a turbocharger.

### SUMMARY OF ILLUSTRATIVE VARIATIONS

A number of variations may include a method comprising: selectively actuating an inlet swirl device to cause a compressor to windmill at a higher speed during an operation mode where fuel consumption of an engine in the vehicle is at a minimal or before an acceleration event.

A number of variations may include a control method for an inlet swirl device in an engine in a vehicle comprising: determining whether the vehicle is operating in at least one of a first mode, a second mode, or a third mode; actuating a plurality of vanes in the inlet swirl device to move to at least one first angle based on at least one engine control operation in the first mode; actuating the plurality of vanes in the inlet swirl device to move to at least one second angle to induce a high level of swirl of a fluid flow exiting the inlet swirl device in the second mode; and actuating the plurality of vanes in the inlet swirl device to move to at least one third angle to induce a high level of swirl of the fluid flow exiting the inlet swirl device in the third mode.

A number of variations may include a control method for an inlet swirl device comprising: providing an inlet swirl device having an actuator and a plurality of vanes operatively connected to the actuator; attaching the inlet swirl device to an internal combustion engine upstream of a compressor; and controlling the angle of the plurality of vanes with the actuator in the inlet swirl device with an electronic control unit in a first mode so that the angle of the plurality of vanes is based on at least one engine operating mode; controlling the angle of the plurality of vanes with the actuator in the inlet swirl device with the electronic control unit in a second mode so that the angle of the plurality of vanes induce a swirl motion of a flow of fluid exiting the inlet swirl device; and controlling the angle of the plurality of vanes with the actuator in the inlet swirl device with the electronic control unit in a third mode so that the angle of the plurality of vanes induce the swirl motion of the flow of fluid exiting the inlet swirl device.

Other illustrative variations within the scope of the invention will become apparent from the detailed description provided hereinafter. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 illustrates a schematic of an internal combustion engine according to a number of variations.

FIG. 2 illustrates a perspective view of an inlet swirl device according to a number of variations.

FIG. 3 illustrates a flow chart of a control method for an inlet swirl device according to a number of variations.

### DETAILED DESCRIPTION OF ILLUSTRATIVE VARIATIONS

The following description of the variations is merely illustrative in nature and is in no way intended to limit the scope of the invention, its application, or uses.

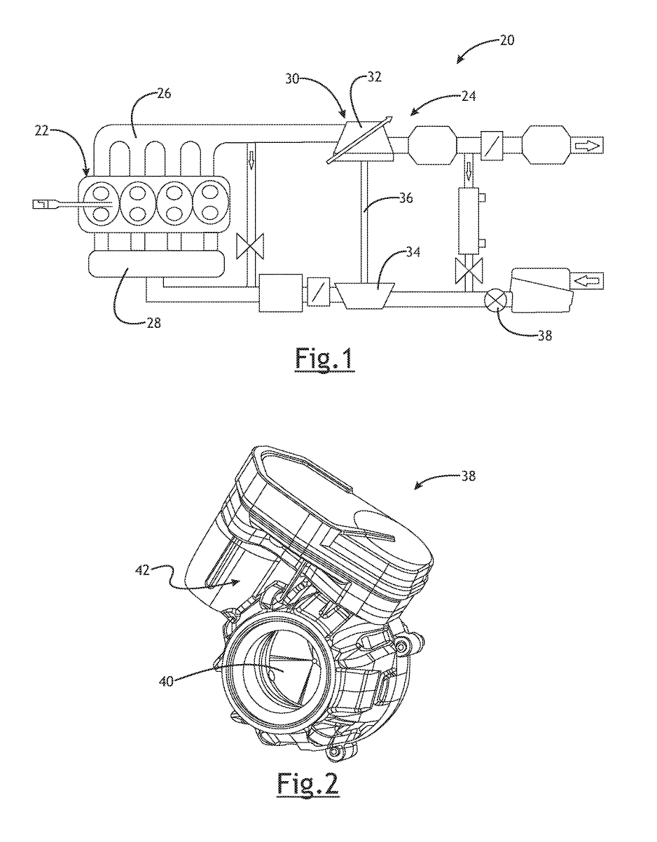

FIG. 1 illustrates a number of variations which may include an internal combustion engine system 20. In a number of variations, an internal combustion engine 22 may combust fuel and may expel fluid in the form of exhaust gasses to an engine breathing system 24. The engine breathing system 24 may manage fluid-flow supplied to, and expelled from the internal combustion engine 22. The engine breathing system 24 may have various arrangements and various engine breathing system components.

In a number of variations, the engine breathing system 24 may include an exhaust manifold 26 which may be equipped on an exhaust side of the internal combustion engine 22 to direct fluid-flow, such as exhaust gasses, exhaled from the internal combustion engine 22 to the engine breathing system 24. An intake manifold 28 may be equipped on an intake side of the internal combustion engine 22 to direct and supply air and/or air-fuel mixture to the internal combustion engine 22.

In a number of variations, the engine breathing system 24 may also include a turbocharger 30. The turbocharger 30 may include a turbine 32 which may be operatively attached to a compressor 34 via a shaft 36. The turbine 32 may be driven by the exhaust gas fluid-flow which may cause the shaft 36 to rotate which may then drive the compressor 34. The compressor 34 may then pressurize air which may enter the internal combustion engine 22.

In a number of variations, an inlet swirl device 38 may be located before or upstream of the compressor 34 and be operatively associated with the compressor 34. Any number of inlet swirl devices 38 may be used including, but not limited to, an inlet swirl device 38 which may include an element or elements that may be operable to selectively influence flow by inducing a swirl motion. The swirl device 38 may also be operated to restrict flow and/or substantially prevent flow through the inlet swirl device 38. The elements in the swirl device 38 may be moved to various positions in any number of variations including, but not limited to, rotating, twisting, morphing, or extending the elements. In one variation, the elements may be in the form of a plurality of vanes 40 which may be moved to any number of angles between approximately 0 to 90 degrees by an actuator 42, a variation of which is illustrated in FIG. 2. An inlet swirl device 38 of this type and configuration is illustrated in U.S. patent application Ser. No. 14/508,151 and is hereby incorporated by reference in its entirety.

In a number of variations, the actuator 42 of the inlet swirl device 38 may be operatively connected to an electronic control unit (ECU) which may be used to control the angle of the inlet swirl device 38. In a number of variations, the ECU may include a main controller and/or a control subsystem which may include one or more controllers (not separately illustrated) in communication with the inlet swirl device 38 for receiving and processing sensor input and transmitting output signals. The controller(s) may include one or more suitable processors and memory devices (not separately illustrated). The memory may be configured to provide storage of data and instructions that provide at least some of the functionality of the engine system and that may be executed by the processor(s). At least portions of the method may be enabled by one or more computer programs and various engine system data or instructions, inlet swirl device 38 operating condition data stored in memory as look-up tables, formulas, algorithms, maps, models, or the like. The control subsystem may control the inlet swirl device 38 parameters by receiving input signals from the sensors, executing instructions or algorithms in light of sensor input signals, and transmitting suitable output signals to the actuator 42. As used herein, the term “model” may include any construct that represents something using variables, such as a look up table, map, formula, algorithm and/or the like. Models may be application specific and particular to the exact design and performance specifications of any given engine system or of the system.

In a number of variations, a vehicle may be operating in a first mode where fuel consumption of the internal combustion engine 22 may be increased or at a maximum including, but not limited to, when the vehicle may be accelerating or maintaining a constant speed. When the vehicle is operating in the first mode, the angle of the plurality of vanes 40 and resulting flow of fluid through the inlet swirl device 38 may be determined by any number of engine control operation algorithms including, but not limited to, algorithms to obtain optimal fuel economy and/or optimal engine output. The angle of the plurality of vanes 40 in the inlet swirl device 38 may vary during operation of the vehicle in the first mode based on the engine operating range in order to achieve optimal engine efficiency. In one illustration, the plurality of vanes 40 in the inlet swirl device 38 may be set at a first angle while the engine operates at a first number of revolutions per minute (rpm) and may be set at a second angle while the engine operates at a second number of rpm. It is noted that the engine may operate at any number of rpms throughout operation of the vehicle in the first mode and, therefore, the angle of the plurality of vanes 40 in the inlet swirl device 38 may also vary in relation to the change in rpm.

In a number of variations, the vehicle may be operating in a second mode where the internal combustion engine 22 fuel consumption may be minimal or zero including, but not limited to, deceleration of the vehicle, coasting of the vehicle, and/or braking of the vehicle. In these modes, the internal combustion engine may require less fuel consumption than may be required when the vehicle may be accelerating or maintaining a constant speed. In the second operating mode, the plurality of vanes 40 may be moved to one or more angles by the actuator 42 to induce a swirl motion of a fluid flow exiting the inlet swirl device 38 which may cause the compressor 34 to “windmill” at a higher speed than the compressor 34 may rotate without the swirl motion from the inlet swirl device 38. In another variation, the plurality of vanes 40 may be set to a fixed angle in the second mode. The angle(s) of the plurality of vanes 40 may be determined by the speed limits of the compressor 34. When the accelerator may be depressed, the compressor 34 may be “windmilling” at a high speed from the swirl motion of the fluid exiting the inlet swirl device 38 so that the compressor may be up to a speed required to efficiently accelerate the vehicle. This may reduce or eliminate the lag between depression of the accelerator and the time the turbocharger 30 may require to get up to speed so that the necessary torque output may be reached more quickly which may recuperate braking and/or coasting energy through stored inertial energy. When the inlet swirl device 38 may be set to one or more angles causing the compressor 34 to “windmill” at a higher speed than the compressor 34 may rotate without the swirl motion from the inlet swirl device 38, it may also reduce the amount of braking required by standard vehicle service brakes by creating a drag.

In a number of variations, a vehicle may operate in a third mode when an operator may perform a manual gear shift and engage/press a clutch in anticipation of an upcoming acceleration event of the vehicle. In the third mode, the plurality of vanes 40 in the inlet swirl device 38 may be moved to various angles to create a swirl motion of a fluid flow exiting the inlet swirl device 38 that may cause the compressor 34 to “windmill” at a higher speed than the compressor 34 may rotate without the swirl motion from the inlet swirl device 38. In another variation, the plurality of vanes 40 may be set to a fixed angle in the third mode. The angle(s) of the plurality of vanes 40 may be determined by the speed limits of the compressor 34. When the clutch may be released, the compressor 34, which may be “windmilling” at a high speed from the swirl motion of the fluid exiting the inlet swirl device 38, may be up to a speed required to efficiently accelerate the vehicle which may reduce or eliminate the lag between shifting the gears and when the turbocharger 30 may be up to a required speed so that the necessary torque output may be reached more quickly.

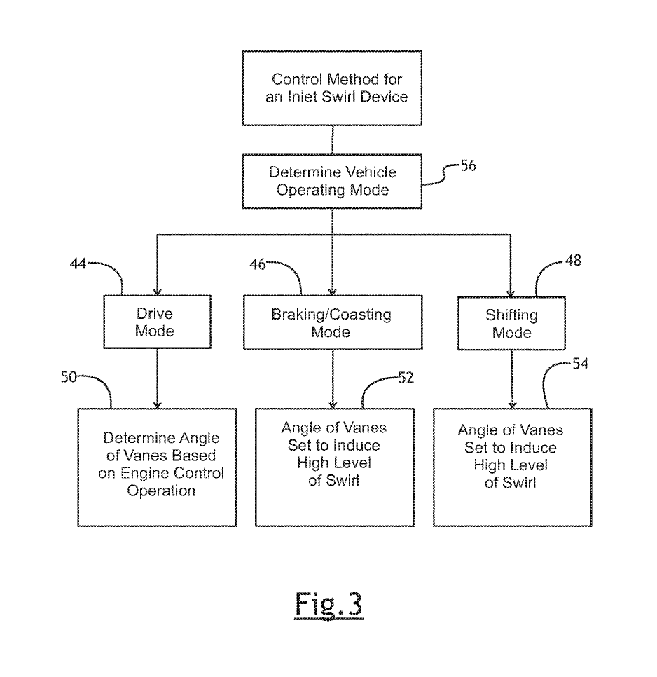

FIG. 3 illustrates a variation of a control method for an inlet swirl device 38. In a number of variations, in a first step 56, the ECU may determine what operating mode 44, 46, 48 the vehicle may be performing in. If the ECU detects that the vehicle is in a drive mode 44, the ECU may send a signal to the inlet swirl device actuator 42 to move the plurality of vanes 40 to one or more angles based on one or more engine operating algorithms 50 including, but not limited to, optimal fuel economy and/or engine output. This may allow the internal combustion engine 22 to perform with maximum efficiency. If the ECU detects that the vehicle has entered a braking/coasting mode 46, the ECU may send a signal to the inlet swirl device actuator 42 to move the plurality of vanes 40 to one or more angles to induce a high level of swirling motion 52 which may cause the compressor 34 to windmill at a higher speed than the compressor 34 may rotate without the swirl motion from the inlet swirl device 38. If the ECU detects that the vehicle has entered a shifting mode 48, the ECU may send a signal to the inlet swirl device actuator 42 to move the plurality of vanes 40 to one or more angles to induce a high level of swirling motion 54 which may cause the compressor 34 to windmill at a higher speed than the compressor 34 may rotate without the swirl motion from the inlet swirl device 38.

The following description of variants is only illustrative of components, elements, acts, products and methods considered to be within the scope of the invention and are not in any way intended to limit such scope by what is specifically disclosed or not expressly set forth. The components, elements, acts, products and methods as described herein may be combined and rearranged other than as expressly described herein and still are considered to be within the scope of the invention.

Variation 1 may include a method comprising: selectively actuating an inlet swirl device to cause a compressor to windmill at a higher speed during an operation mode where fuel consumption of an engine in the vehicle is at a minimal or before an acceleration event.

Variation 2 may include a method as set forth in Variation 1 wherein the operation mode is at least one of a braking mode, a deceleration mode, or a coasting mode.

Variation 3 may include a method as set forth in any of Variations 1-2 wherein the operation mode is a gear shift.

Variation 4 may include a control method for an inlet swirl device in an engine in a vehicle comprising: determining whether the vehicle is operating in at least one of a first mode, a second mode, or a third mode; actuating a plurality of vanes in the inlet swirl device to move to at least one first angle based on at least one engine control operation in the first mode; actuating the plurality of vanes in the inlet swirl device to move to at least one second angle to induce a high level of swirl of a fluid flow exiting the inlet swirl device in the second mode; and actuating the plurality of vanes in the inlet swirl device to move to at least one third angle to induce the high level of swirl of the fluid flow exiting the inlet swirl device in the third mode.

Variation 5 may include a control method as set forth in Variation 4 wherein in the first mode, fuel consumption by the engine is high, and wherein in the second mode fuel consumption by the engine is at a minimum.

Variation 6 may include a control method as set forth in any of Variations 4-5 wherein in the third mode, an acceleration event of the vehicle is anticipated.

Variation 7 may include a control method as set forth in any of Variations 4-6 wherein the at least one first angle achieves maximum efficiency of the engine and the at least one second angle and the at least one third angle cause a compressor in the engine to windmill at a high speed.

Variation 8 may include a control method as set forth in any of Variations 4-7 where in the first mode the vehicle is accelerating.

Variation 9 may include a control method as set forth in any of Variations 4-8 where in the second mode the vehicle is at least one of braking, coasting, or decelerating.

Variation 10 may include a control method as set forth in any of Variations 4-9 where in the third mode the vehicle is shifting.

Variation 11 may include a control method for an inlet swirl device comprising: providing an inlet swirl device having an actuator and a plurality of vanes operatively connected to the actuator; attaching the inlet swirl device to an internal combustion engine upstream of a compressor; and controlling the angle of the plurality of vanes with the actuator in the inlet swirl device with an electronic control unit in a first mode so that the angle of the plurality of vanes is based on at least one engine operating mode; controlling the angle of the plurality of vanes with the actuator in the inlet swirl device with the electronic control unit in a second mode so that the angle of the plurality of vanes induce a swirl motion of a flow of fluid exiting the inlet swirl device; and controlling the angle of the plurality of vanes with the actuator in the inlet swirl device with the electronic control unit in a third mode so that the angle of the plurality of vanes induce the swirl motion of the flow of fluid exiting the inlet swirl device.

Variation 12 may include a control method as set forth in Variation 11 wherein the swirl motion of the flow of fluid exiting the inlet swirl device causes the compressor upstream of the inlet swirl device to windmill at a high speed.

Variation 13 may include a control method as set forth in any of Variations 11-12 wherein in the first mode, the angle of the plurality of vanes varies in relation to one or more engine operating ranges to obtain optimal engine efficiency.

Variation 14 may include a control method as set forth in any of Variations 11-13 wherein in the first mode, fuel consumption of the internal combustion engine is high and in the second mode, fuel consumption of the internal combustion engine is at a minimal.

Variation 15 may include a control method as set forth in any of Variations 11-14 wherein the internal combustion engine is operatively connected to a vehicle.

Variation 16 may include a control method as set forth in Variation 15 wherein when the compressor windmills at the high speed, drag between depression of an accelerator in the vehicle and a time for a turbocharger in the vehicle to speed up is reduced.

Variation 17 may include a control method as set forth in any of Variations 15-16 wherein when the compressor windmills at the high speed, drag between shifting of a plurality of gears in the vehicle and a time for a turbocharger in the vehicle to speed up is reduced.

Variation 18 may include a control method as set forth in any of Variations 15-17 wherein in the third mode, an acceleration event of the vehicle is anticipated.

Variation 19 may include a control method as set forth in any of Variations 15-18 wherein in the first mode, the vehicle is accelerating and in the second mode the vehicle is at least one of braking, decelerating, or coasting.

Variation 20 may include a control method as set forth in any of Variations 15-19 wherein in the third mode the vehicle is manually shifting.

The above description of select variations within the scope of the invention is merely illustrative in nature and, thus, variations or variants thereof are not to be regarded as a departure from the spirit and scope of the invention.

What is claimed is:

1. A method comprising:
selectively actuating an inlet swirl device to cause a compressor to windmill at a higher speed during an operation mode where fuel consumption of an engine in the vehicle is at a minimal or before an acceleration event.

2. The method of claim 1 wherein the operation mode is at least one of a braking mode, a deceleration mode, or a coasting mode.

3. The method of claim 1 wherein the operation mode is a gear shift.

4. A control method for an inlet swirl device in an engine in a vehicle comprising:
determining whether the vehicle is operating in at least one of a first mode, a second mode, or a third mode;
actuating a plurality of vanes in the inlet swirl device to move to at least one first angle based on at least one engine control operation in the first mode;
actuating the plurality of vanes in the inlet swirl device to move to at least one second angle to induce a high level of swirl of a fluid flow exiting the inlet swirl device in the second mode; and
actuating the plurality of vanes in the inlet swirl device to move to at least one third angle to induce the high level of swirl of the fluid flow exiting the inlet swirl device in the third mode.

5. The control method of claim 4 wherein in the first mode, fuel consumption by the engine is high, and wherein in the second mode fuel consumption by the engine is at a minimum.

6. The control method of claim 4 wherein in the third mode, an acceleration event of the vehicle is anticipated.

7. The control method of claim 4 wherein the at least one first angle achieves maximum efficiency of the engine and the at least one second angle and the at least one third angle cause a compressor in the engine to windmill at a high speed.

8. The control method of claim 4 where in the first mode the vehicle is accelerating.

9. The control method of claim 4 where in the second mode the vehicle is at least one of braking, coasting, or decelerating.

10. The control method of claim 4 where in the third mode the vehicle is shifting.

11. A control method for an inlet swirl device comprising:
providing an inlet swirl device having an actuator and a plurality of vanes operatively connected to the actuator;
attaching the inlet swirl device to an internal combustion engine upstream of a compressor; and
controlling the angle of the plurality of vanes with the actuator in the inlet swirl device with an electronic control unit in a first mode so that the angle of the plurality of vanes is based on at least one engine operating mode;
controlling the angle of the plurality of vanes with the actuator in the inlet swirl device with the electronic control unit in a second mode so that the angle of the plurality of vanes induce a swirl motion of a flow of fluid exiting the inlet swirl device; and
controlling the angle of the plurality of vanes with the actuator in the inlet swirl device with the electronic control unit in a third mode so that the angle of the plurality of vanes induce the swirl motion of the flow of fluid exiting the inlet swirl device.

12. The control method of claim 11 wherein the swirl motion of the flow of fluid exiting the inlet swirl device causes the compressor upstream of the inlet swirl device to windmill at a high speed.

13. The control method of claim 11 wherein in the first mode, the angle of the plurality of vanes varies in relation to one or more engine operating ranges to obtain optimal engine efficiency.

14. The control method of claim 11 wherein in the first mode, fuel consumption of the internal combustion engine is high and in the second mode, fuel consumption of the internal combustion engine is at a minimal.

15. The control method of claim 12 wherein the internal combustion engine is operatively connected to a vehicle.

16. The control method of claim 15 wherein when the compressor windmills at the high speed, drag between depression of an accelerator in the vehicle and a time for a turbocharger in the vehicle to speed up is reduced.

17. The control method of claim 15 wherein when the compressor windmills at the high speed, drag between shifting of a plurality of gears in the vehicle and a time for a turbocharger in the vehicle to speed up is reduced.

18. The control method of claim 15 where in the third mode, an acceleration event of the vehicle is anticipated.

19. The control method of claim 15 where in the first mode, the vehicle is accelerating and in the second mode the vehicle is at least one of braking, decelerating, or coasting.

20. The control method of claim 15 where in the third mode the vehicle is manually shifting.
